(19) United States
(12) Patent Application Publication
(10) Pub. No.: US 2018/0257335 A1
(43) Pub. Date: Sep. 13, 2018

(54) TRANSPARENT SHEET, TRANSPARENT SCREEN COMPRISING SAME, AND IMAGE PROJECTION DEVICE COMPRISING SAME

(71) Applicants: JXTG NIPPON OIL & ENERGY CORPORATION, Tokyo (JP); TOKYO INSTITUTE OF TECHNOLOGY, Tokyo (JP)

(72) Inventors: Akira MATSUO, Tokyo (JP); Suzushi NISHIMURA, Tokyo (JP); Kousuke YAMAKI, Tokyo (JP); Koichi SAKAJIRI, Tokyo (JP); Junji WATANABE, Tokyo (JP)

(73) Assignees: JXTG NIPPON OIL & ENERGY CORPORATION, Tokyo (JP); TOKYO INSTITUTE OF TECHNOLOGY, Tokyo (JP)

(21) Appl. No.: 15/534,264

(22) PCT Filed: Dec. 4, 2015
(86) PCT No.: PCT/JP2015/084213

§ 371 Date: Jun. 8, 2017

(30) Foreign Application Priority Data
Dec. 11, 2014 (JP) 2014-250948
May 22, 2015 (JP) 2015-104892

(51) Int. Cl. B32B 7/02; B32B 27/20; G02B 5/02; G03B 21/62; H04N 5/74; B32B 27/08; B32B 27/36; B32B 7/12

(52) U.S. Cl. CPC B32B 7/02; B32B 27/20; G02B 5/02; G03B 21/62; B32B 2307/412; B32B 27/08; B32B 27/365; B32B 7/12; H04N 5/74

(57) ABSTRACT

Provided is a transparent sheet which can clearly display merchandise information, advertisement, or the like on a transparent partition or the like by projection without compromising the transmission visibility and which have a wide viewing angle. The transparent sheet includes an optical diffusion layer comprising: a resin having a refractive index n₁; and microparticles having a refractive index n₂ different from the refractive index n₁, wherein the thickness of the optical diffusion layer is from over 400 μm to 20 mm or less.

### TECHNICAL FIELD

The present invention relates to a transparent sheet suitably used for a projection type image display screen. The present invention also relates to a transparent screen comprising said transparent sheet and an image projection device comprising said transparent screen.

### BACKGROUND ART

Conventionally, a combination of a Fresnel lens sheet and a lenticular lens sheet has been used for a projector screen. In recent years, a demand for displaying merchandise information, advertisement, or the like by projection on a shop window of a department store or the like, a transparent partition of an event venue, or the like while maintaining the transparency thereof is growing. It is said that, in the future, a demand for a highly transparent projection type image display screen which is used for a head-up display, a wearable display, or the like will be further increasing.

However, since a conventional projector screen has a low transparency, there is a technical problem that such projector screen cannot be applied to a transparent partition, or the like. Accordingly, as a projector screen, a screen having a recess on its surface is proposed (see Patent Document 1). A transparent optical diffusion material containing a thin film (from 0.2 to 400 μm) with nano particles of a high refractive index dispersed in the dispersion medium is proposed to obtain a highly transparent transmission type screen (see Patent Document 2). Further, in order to prevent a reflection on the surface of a variety of screens such as a transmission type screen or a reflection type screen, it is proposed that an antiglare member having an antiglare layer composed of black microparticles and a transparent binder is disposed on the surface of such screens (see Patent Document 3).

### RELATED ART DOCUMENTS

### Patent Documents

Patent Document 1 Japanese Unexamined Patent Application Publication No. 2006-146019

Patent Document 2 Japanese Unexamined Patent Application Publication No. 2014-153708

Patent Document 3 U.S. Pat. No. 4,571,691

### SUMMARY OF THE INVENTION

### Problems to be Solved by the Invention

However, the present inventors found the following technical problems in Patent Documents 1 to 3. When a screen described in Patent Document 1 is applied to a transparent partition or the like of a shop window or an event venue, there is a technical problem that the screen cannot maintain the performance for a long period of time since the concavoconvex portion wears with its usage. There is also a technical problem that a film clouds and the transparency is compromised since the diameter of optical diffusion particles is 1 to 20 μm. The transparent optical diffusion material described in Patent Document 2 is a thin film and poor in diffusing transmitted light, therefore have a technical problem of a narrow viewing angle, when used as a transmission type screen. A screen described in Patent Document 4 has a technical problem that the transparency is poor and the screen is grayish due to an influence of a carbon black since the screen comprises an antiglare member including black microparticles such as a carbon black having an average particle size of 1 to 6 μm.

### Means for Solving the Problems

The present invention has been made in view of the above-described technical problems, and an object of the present invention is to provide a transparent sheet which can clearly display merchandise information, advertisement, or the like on a transparent partition or the like by projection without compromising the transmission visibility and which has a wide viewing angle. An object of the present invention is to provide a transparent screen comprising the transparent sheet or an image projection device comprising the transparent sheet or the transparent screen and a projection device.

In order to solve the above described technical problems, the present inventors intensively studied to find that the above described technical problems can be solved by forming an optical diffusion layer using a resin having a refractive index n₁ and microparticles having a refractive index n₂ different from the refractive index n₁, and adjusting the thickness of the optical diffusion layer within the range from over 400 μm to 20 mm or less. The present invention has been completed based on such findings.

That is, according to one aspect of the present invention, provided is a transparent sheet comprising an optical diffusion layer comprising a resin having a refractive index n₁ and microparticles having a refractive index n₂ different from the refractive index n₁, in which the thickness of the optical diffusion layer is from over 400 μm to 20 mm or less.

According to one aspect of the present invention, the optical diffusion layer preferably satisfies the following formula (1)

Refractive index n₂−Refractive index n₁≥0.1 (1)

According to one aspect of the present invention, the content of the microparticles is preferably from 0.0001 to 0.50% by mass based on the resin.

According to one aspect of the present invention, primary particles of the microparticles preferably have a median diameter of from 0.1 to 100 nm and a maximum particle diameter of 10 to 500 nm.

According to one aspect of the present invention, the microparticles are preferably at least one inorganic microparticle, selected from the group consisting of zirconium oxide, titanium oxide, zinc oxide, cerium oxide, barium titanate, diamond, and strontium titanate.

According to one aspect of the present invention, the optical diffusion layer preferably comprises a thermoplastic resin.

According to one aspect of the present invention, the thermoplastic resin preferably comprises at least one selected from the group consisting of an acrylic resin, a polyester resin, a polyolefin resin, a vinyl resin, a polycarbonate resin, and a polystyrene resin.

According to one aspect of the present invention, the thermoplastic resin preferably comprises at least one selected from the group consisting of a polymethyl methacrylate resin, a polyethylene terephthalate resin, a polyethylene naphthalate resin, a polypropylene resin, a cycloolefin polymer resin, a polyvinyl butyral resin, a polycarbonate resin, and a polystyrene resin.

According to one aspect of the present invention, the total light transmittance of the transparent sheet is preferably 70% or more.

According to one aspect of the present invention, the diffusion transmittance of the transparent sheet is preferably from 1.5% to 60% or less.

According to one aspect of the present invention, the haze value of the transparent sheet is preferably 85% or less.

According to one aspect of the present invention, the image clarity of the transparent film is preferably 70% or higher.

In another aspect of the present invention, a transparent screen is provided, comprising the transparent sheet described above.

In another aspect of the present invention, a layered body is provided, comprising the transparent sheet or the transparent screen described above.

In another aspect of the present invention, a member for a vehicle is provided, comprising the transparent sheet or the transparent screen described above.

In another aspect of the present invention, a member for a house is provided, comprising the transparent sheet or the transparent screen described above.

In another aspect of the present invention, an image projection device is provided, comprising the above described transparent sheet or transparent screen and a projection device.

### Effects of the Invention

When a transparent sheet of the present invention is used as a transparent screen, clear display of merchandise information, advertisement, or the like on a transparent partition or the like by projection is possible without compromising the transmission visibility, and in addition, the viewing angle is wide. That is, since such a transparent sheet has excellent transparency and image clarity, it can be suitably used as a transparent screen and further for a member for a vehicle or a house. Such a transparent sheet can also be suitably used for a light guide plate used in an image display device, an image projection device, a light source for a scanner, or the like.

### BRIEF DESCRIPTION OF THE DRAWINGS

FIG. 1 is a cross-sectional schematic diagram in the thickness direction of one embodiment of a transparent sheet having a thick film according to the present invention.

FIG. 2 is a cross-sectional schematic diagram in the thickness direction of a transparent sheet having a conventional thin film.

FIG. 3 is a schematic diagram illustrating one embodiment of a transparent screen and an image projection device according to the present invention.

### MODE FOR CARRYING OUT THE INVENTION

### <Transparent Sheet>

A transparent sheet according to the present invention comprises an optical diffusion layer. The transparent sheet can be suitably used as a transparent screen, and a clear image can be formed on the transparent sheet without compromising the transmission visibility. Especially, the transparent sheet comprising a thick film optical diffusion layer as below will enhance the diffusion effect of the projection light and thus can improve the viewing angle. The transparent sheet may be a single-ply constitution comprising the optical diffusion layer, or a layered body of a multi-ply constitution further comprising other layers such as a protection layer, a backing layer, an adhesive layer and a reflection protection layer.

The transparent sheet according to the present invention may be used as the transparent screen directly, or by sticking to a support of a transparent partition, or the like. Since it is demanded that the transmission visibility of the transparent screen is not compromised, preferably, the transmittance of the transparent sheet for a visible light is high and the transparency thereof is high. In the present invention, the term “transparent” means transparent in the degree that a transmission visibility depending on the applications is attained and also includes being “translucent”.

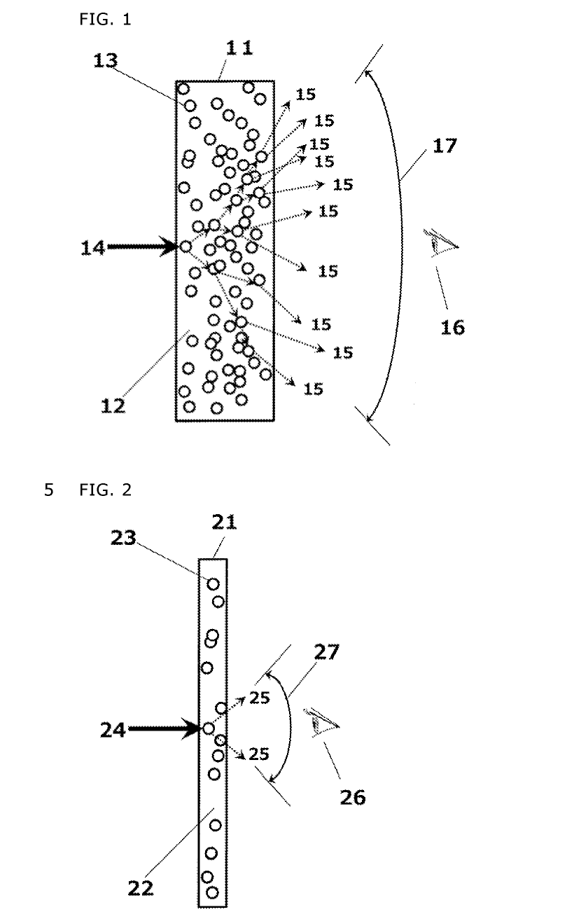

FIG. 1 is a cross-sectional schematic diagram in the thickness direction, illustrating one embodiment of a thick film transparent sheet according to the present invention. FIG. 2 is a cross-sectional schematic diagram in the thickness direction, illustrating a conventional thin film transparent sheet. The thick film transparent sheet according to the preset invention as shown in FIG. 1 comprises an optical diffusion layer 11, in which microparticles 13 are diffused in a resin 12. The transparent sheet 11 according to the present invention has sufficient thickness in the cross-sectional direction so that an entering light 14 is anisotropically diffused sufficiently by the microparticles 13. Therefore, a viewing angle (an image visible region) 17 of a viewer 16 against a diffusion light 15 becomes wide. On the other hand, since the thickness is thin in the cross-sectional direction of a conventional thin membranes transparent sheet 21 as shown in FIG. 2, an entering light 24 is not diffused sufficiently by microparticles 23 dispersed in a resin 22. Therefore, a viewing angle (an image visible region) 27 of a viewer 26 against a diffusion light 25 becomes narrow.

The haze value of the transparent sheet is preferably 85% or less, more preferably from 1% to 70% or less, more preferably from 1.3% to 40% or less, and still more preferably from 1.5% to 20% or less. The diffusion transmittance of the transparent sheet is preferably from 1.5% to 60% or less, more preferably from 1.7% to 55% or less, more preferably from 1.9% to 50% or less, and still more preferably from 2.0% to 45% or less. The total light transmittance of the transparent sheet is preferably 70% or higher, more preferably 75% or higher, still preferably 80% or higher, and still more preferably 85% or higher. The transparency will be high and the transmission visibility will be more improved if the haze value and the total light transmittance of the transparent sheet are within the above-described ranges. When the diffusion transmittance is within the above-described range, the entering light will be efficiently diffused and thus the viewing angle can be improved. In the present invention, the haze value, the diffusion transmittance, and the total light transmittance of the transparent sheet can be measured by using a turbidimeter (Part No.: NDH-5000; manufactured by NIPPON DENSHOKU INDUSTRIES CO., LTD.) in accordance with JIS-K-7361 and JIS-K-7136.

The image clarity of the transparent sheet is preferably 70% or higher, more preferably 75% or higher, further preferably 80% or higher, still more preferably 85% or higher, and particularly preferably 90% or higher. An image transmitted through a transparent screen to be seen will be remarkably clear when the image clarity of the transparent sheet is within the above-described range. In the present invention, the image clarity is a value of definition (%) when measured with an optical comb having a width of 0.125 mm in accordance with JIS K7374.

The frontal luminous intensity (×1000) of the transparent sheet is preferably 0.05 or higher, more preferably 0.1 or higher, and still preferably from 0.2 to 50 or less. The viewing angle of the transparent sheet is preferably from ±3 to ±90, more preferably from ±5 to ±90, and still preferably from ±8 to ±90. When the frontal luminous intensity and the viewing angle are within the above-described ranges, the luminance of the image light and also the the viewing angle characterisitic is high and therefore result in a transparent screen of excellent performance. In the present invention, the frontal luminous intensity and the viewing angle of the transparent sheet are values measured in such way as follows.

### (Frontal Luminous Intensity)

The frontal luminous intensity is measured by using a goniophotometer (Part No.: GC5000L; manufactured by NIPPON DENSHOKU INDUSTRIES CO., LTD.). An entering angle of a light source is set to 0 degree, and a transmitted light intensity in the direction of 0 degree with nothing placed on the measuring stage is 100. When a sample is measured, the entering angle of the light source is set to 15 degrees, corresponding to a set angle of a common projector, and the intensity of the transmitted light in the direction of 0 degree is measured.

### (Viewing Angle)

The viewing angle is measured by using a goniophotometer (Part No.: GC5000L; manufactured by NIPPON DENSHOKU INDUSTRIES CO., LTD.). An entering angle of a light source is set to 0 degree, and a transmitted light intensity in the direction of 0 degree with nothing placed on the measuring stage is 100. When a sample is measured, the transmitted light intensity is measured by 1 degree from −85 degrees to +85 degrees with the entering angle of the light source kept at 0 degree. Among the measured range, the range having the transmitted light intensity of 0.001 or higher is the viewing angle.

The thickness of the transparent sheet is preferably from over 400 μm to 20 mm (20000 μm) or less, more preferably from 500 μm to 15 mm (15000 μm) or less, still preferably from 1 mm (1000 μm) to 12 mm (12000 μm) or less, and still more preferably from 1.5 mm (1500 μm) to 10 mm (10000 μm) or less. In the present invention, the term “transparent sheet” includes various forms of moldings such as what is called a film, a sheet, a plate (a plate form molding), and a laminated body (made by sticking together multiple sheets of films, sheets or plates).

### (Optical Diffusion Layer)

The optical diffusion layer comprises a resin having a refractive index n₁ and microparticles having a refractive index n₂ different from the refractive index n₁. The difference in the refractive indices of the resin and the microparticles forming the optical diffusion layer will diffuse the light anisotropically in the optical diffusion layer, and thus the viewing angle can be improved.

The optical diffusion layer preferably satisfies the following formula (1):

Refractive index n₂−Refractive index n₁≥0.1 (1),

more preferably fulfils the following formula (2):

Refractive index n₂−Refractive index n₁≥0.15 (2), and

still preferably fulfils the following formula (3):

1.5≥Refractive index n₂−Refractive index n₁≥0.2 (3).

When the refractive index n₁ of the resin and refractive index n₂ of the microparticles, forming the optical diffusion layer, satisfy the above-mentioned relational formulae, the light is sufficiently diffused in the optical diffusion layer, and thus the viewing angle can be further improved.

The thickness of the optical diffusion layer is from over 400 μm to 20 mm (20000 μm), preferably from 500 μm to 15 mm (15000 μm), more preferably from 900 μm to 12 mm (12000 μm), still preferably from 1 mm (1000 μm) to 10 mm (10000 μm), and still more preferably from 1.5 μm (1500 μm) to 5 mm (5000 μm). When the thickness of the optical diffusion layer is within the above-mentioned range, both the visibilities of the diffused light and the transmitted light will be satisfied by diffusing anisotropically the projection light sufficiently, emitted from the projection device, while ensuring the transparency of the optical diffusion layer. The optical diffusion layer may be of a single layer construction or a multiple layer construction, made by sticking together 2 or more layers with an adhesive, or the like.

### (Resin)

As a resin forming the optical diffusion layer, a highly transparent resin is preferably used in order to obtain a transparent sheet of a high transparence. For a highly transparent resin, a thermoplastic resin such as an acrylic resin, an acrylic urethane resin, a polyester acrylate resin, a polyurethane acrylate resin, an epoxy acrylate resin, a polyester resin, a polyolefin resin, a urethane resin, an epoxy resin, a polycarbonate resin, a cellulose resin, an acetal resin, a vinyl resin, a polystyrene resin, a polyamide resin, a polyimide resin, a melamine resin, a phenol resin, a silicone resin, a polyarylate resin, a polyvinyl alcohol resin, a polyvinyl chloride resin, a poly sulfone resin, and a fluorocarbon resin; a thermoset resin; an ionizing radiation-curable resin; or the like can be used. Among these, a thermoplastic resin is preferably used in view of formability of the transparent sheet but without specific limitation. As thermoplastic resins, preferably, an acrylic resin, a polyester resin, a polyolefin resin, a vinyl resin, a polycarbonate resin, and a polystyrene resin are used, and more preferably, a polymethyl methacrylate resin, a polyethylene terephthalate resin, a polyethylene naphthalate resin, a polypropylene resin, a cycloolefin polymer resin, a cellulose acetate propionate resin, a polyvinyl butyral resin, a polycarbonate resin, and a polystyrene resin are used. These resins may be used singly, or in combination of two or more kinds thereof. The ionizing radiation-curable resin includes an acrylic resin, a urethane resin, an acrylic urethane resin, an epoxy resin, and a silicone resin. Among these, those having an acrylate functional group, for example, those containing a relatively high amount of a monofunctional monomer such as ethyl (meth)acrylate, ethylhexyl (meth)acrylate, styrene, methyl styrene, N-vinylpyrrolidone and a polyfunctional monomer, such as polymethylolpropane tri(meth)acrylate, hexane diol (meth)acrylate, tripropylene glycol di(meth)acrylate, diethylene glycol di(meth)acrylate, pentaerythritol tri(meth)acrylate, dipentaerythritol hexa(meth)acrylate, 1,6-hexane diol di(meth)acrylate, neopentyl glycol di(meth)acrylate as an oligomer or a prepolymer of a polyester resin, a polyether resin, an acrylic resin, an epoxy resin, a urethane resin, an alkyd resin, a spiroacetal resin, a polybutadiene resin, a polythiol polyene resin, a (meth)acrylate of a polyfunctional compound such as a polyalcohol and a reactivity diluent having a relatively low molecular weight are preferable. The ionizing radiation-curable resin may be obtained by mixing a thermoplastic resin and a solvent. The thermoset resin includes a phenol resin, an epoxy resin, a silicone resin, a melamine resin, a urethane resin, and a urea resin. Among these, an epoxy resin and a silicone resin are preferable.

### (Microparticles)

As microparticles forming the optical diffusion layer, an inorganic or an organic matter that can be atomized in a nano size may be suitably used, and preferably, high refractive index particles are used which fulfil the above formula (1). As inorganic microparticles having a high refractive index, for example, the refractive index n₂ is preferably from 1.80 to 3.55, more preferably from 1.9 to 3.3, and still preferably from 2.0 to 3.0. As the inorganic microparticles having such a high refractive index, diamond (n=2.42), metal oxide, metal salt, and metallic particles from atomizing pure metal, or the like can be used. The metal oxides include, for example, zirconium oxide (n=2.40), titanium oxide (n=2.72), oxidation zinc (n=2.40), and cerium oxide (n=2.20). The metal salts include, for example, barium titanate (n=2.40) and strontium titanate (n=2.37). The pure metals include, for example, silver, gold, platinum, palladium, or the like. Especially, at least one inorganic microparticle is preferably used, selected from zirconium oxide, titanium oxide, oxidation zinc, cerium oxide, barium titanate, and strontium titanate, in view of diffusion of the projection light, aggregation of the particles, and the manufacturing cost. These inorganic microparticles may be used singly of one kind, or in combination of two or more kinds thereof.

Primary particles of the microparticles have a median diameter (D₅₀) of from 0.1 to 100 nm, preferably of from 0.5 to 50 nm, more preferably of from 1 to 35 nm, and still preferably from 1.5 to 30 nm, and have a maximum particle size of from 10 to 500 nm, preferably of from 15 to 300 nm, more preferably of from 20 to 200 nm, and still preferably of from 20 to 130 nm. With the median diameter and the maximum particle size of the primary particles of the microparticles being within the above range and by using the transparent sheet, a clear image can be projected on the transparent screen since a sufficient diffusion effect of the projection light is obtained without compromising the transmission visibility. In the present invention, the median diameter (D₅₀) and the maximum particle size of the primary particles of the inorganic microparticles can be determined from a particle size distribution measured using a particle size distribution measurement apparatus (Trade name: DLS-8000; manufactured by Otsuka Electronics Co., Ltd.) by a dynamic light scattering method.

For the inorganic microparticles, those commercially available may be used, and for the zirconium oxide particles, SZR-W, SZR-CW, SZR-M, SZR-K, and the like (the above, manufactured by SAKAI CHEMICAL INDUSTRY CO., LTD., trade name) can be suitably used.

The content of the microparticles in the optical diffusion layer can be appropriately adjusted, depending on the thickness of the optical diffusion layer and the refractive index of the microparticles. The content of the microparticles in the optical diffusion layer is preferably from 0.0001 to 0.50% by mass, more preferably from 0.001 to 0.40% by mass, still preferably from 0.002 to 0.10% by mass, still more preferably from 0.005 to 0.05% by mass, based on the resin. When the content of the inorganic microparticles in the optical diffusion layer is within the above-mentioned range, both the visibilities of the diffused light and the transmitted light can be satisfied by diffusing anisotropically the projection light sufficiently, emitted from the projection device, while ensuring the transparency of the optical diffusion layer.

### (Backing Layer)

A backing layer is a layer for supporting the transparent sheet, which can improve the strength of the transparent sheet. The backing layer is preferably formed by using a highly transparent resin or glass, which does not compromise the transmission visibility or the desired optical property of the transparent sheet. For such a resin, a highly transparent resin similar to the optical diffusion layer described above can be used. That means, an acrylic resin, an acrylic urethane resin, a polyester acrylate resin, a polyurethane acrylate resin, an epoxy acrylate resin, a polyester resin, a polyolefin resin, a urethane resin, an epoxy resin, a polycarbonate resin, a cellulose resin, an acetal resin, a vinyl resin, a polystyrene resin, a polyamide resin, a polyimide resin, a melamine resin, a phenol resin, a silicone resin, a polyarylate resin, a polyvinyl alcohol resin, a polyvinyl chloride resin, a polysulfone resin, and a fluorocarbon resin; a thermoset resin; an ionizing radiation-curable resin; or the like can be suitably used. Also, a transparent sheet formed by layering two or more resins described above may be used. The thickness of the backing layer can be appropriately changed depending on the type of the material so that the strength thereof is suitable, and the thickness may be, for example, in the range of from 10 to 1000 μm.

### (Protection Layer)

A protection layer is layered on both or either of the front side (the viewer side) and the back side of the transparent sheet, and is a layer for imparting a function such as light resistance, scratch resistance, substrate adhesiveness, and stain resistance. The protection layer is preferably formed by using a resin which does not compromise the transmission visibility or the desired optical property of the transparent sheet.

Materials for such protection layer include, for example, polyester resins such as a polyethylene terephthalate and a polyethylene naphthalate; cellulosic resins such as a diacetylcellulose and a triacetylcellulose; acryl resins such as a a polymethyl methacrylate; styrene resins such as a polystyrene and an acrylonitrile-styrene copolymer (an AS resin); a polycarbonate resin; or the like. Examples of the resins that forms the protection layer include: polyolefin resins such as a polyethylene, a polypropylene, and an ethylene-propylene copolymer; a cyclo olefin resin or an olefin resin having a norbornene structure; a vinyl chloride resin; amide resins such as nylon and an aromatic polyamide; an imide resin; a sulfone resin; a polyether sulfone resin; a polyether ether ketone resin: a polyphenylene sulfide resin; a vinyl alcohol resin; a vinylidene chloride resin; a vinyl butyral resin; an arylate resin; a polyoxymethylene resin; an epoxy resin; or the blends of such resins. Others include: ionizing radiation-curable resin such as resins of an acrylic or a urethane, an acrylic urethane or an epoxy, or a silicone; a mixture of an ionizing radiation-curable resin with a thermoplastic resin and a solvent; a thermoset resin.

For a film forming component of the ionizing radiation-curable resin composition, preferably, those having an acrylate functional group, for example, those containing a relatively large amount of a monofunctional monomer such as ethyl (meth)acrylate, ethylhexyl (meth)acrylate, styrene, methyl styrene, N-vinylpyrrolidone and a polyfunctional monomer, such as polymethylolpropane tri(meth)acrylate, hexane diol (meth)acrylate, tripropylene glycol di(meth)acrylate, diethylene glycol di(meth)acrylate, pentaerythritol tri(meth)acrylate, dipentaerythritol hexa(meth)acrylate, 1,6-hexane diol di(meth)acrylate, neopentyl glycol di(meth)acrylate as an oligomer or a prepolymer of a polyester resin, a polyether resin, an acrylic resin, an epoxy resin, a urethane resin, an alkyd resin, a spiroacetal resin, a polybutadiene resin, a polythiol polyene resin, a (meth)acrylate of a polyfunctional compound such as a polyalcohol and a reactivity diluent having a relatively low molecular weight can be used.

In order to make the above-described ionizing radiation-curable resin composition an ultraviolet light curable resin composition, acetophenones, benzophenons, Michler's benzoyl benzoates, α-amidoxime esters, tetramethyl thiuram monosulfides, and thioxanthones as photopolymerization initiators, and n-butyl amine, triethylamine, and poly-n-butylphosphine as photosensitizers may be added thereto to be used. In particular, in the present invention, a urethane acrylate as an oligomer and a dipentaerythritol hexa(meth)acrylate or the like as a monomer are preferably mixed.

An ionizing radiation-curable resin composition can be cured by irradiation of an electron beam or an ultraviolet light using a normal curing method as a curing method. For example, in the case of electron beam curing, an electron beam having an energy of 50 to 1000 KeV, and preferably 100 to 300 KeV released from a variety of electron beam accelerators such as Cockcroft-Walton-type, Van de Graaff-type, resonance transformer-type, insulating core transformer-type, linear-type, Dynamitron-type, and high-frequency-type is used, and in the case of ultraviolet light curing, a ultraviolet light or the like emitted from a light beam such as an ultra-high pressure mercury lamp, a high pressure mercury lamp, a low pressure mercury lamp, a carbon arc, a xenon arc, and a metal halide lamp can be used.

A protection layer can be formed by applying a coating of the above-described ionizing radiation (ultraviolet light)-curable resin composition by a method such as spin coating, die coating, dip coating, bar coating, flow coating, roll coating, or gravure coating, on both or either of the front side (viewer side) and the back side of the transparent sheet as described above, and by curing the coating by the above-described means. To the surface of the protection layer, a microstructure such as a concavoconvex structure, a prism structure, or a microlens structure can also be provided depending on the purposes.

### (Adhesive Layer)

An adhesive layer is a layer for sticking the transparent sheet to a support. The adhesive layer is preferably formed by using an adhesive composition which does not compromise the transmission visibility or the desired optical property of the transparent sheet. Examples of the adhesive composition include a natural rubber, a synthetic rubber, an acryl resin, a polyvinyl ether resin, a urethane resin, and a silicone resin. Specific examples of the synthetic rubber include a styrene-butadiene rubber, an acrylonitrile-butadiene rubber, a polyisobutylene rubber, an isobutylene-isoprene rubber, a styrene-isoprene block copolymer, a styrene-butadiene block copolymer, and a styrene-ethylene-butylene block copolymer. Specific examples of the silicone resin include a dimethyl polysiloxane. These adhesives can be used singly or in combination of two or more kinds thereof. Among these, an acrylic adhesive is preferable.

An acrylic resin adhesive includes at least an alkyl (meth)acrylate monomer and is formed by polymerization. Copolymerization of an alkyl (meth)acrylate monomer having an alkyl group having the number of carbon atoms of 1 to about 18 and a monomer having a carboxyl group is usually employed. A (meth)acrylic acid means an acrylic acid and/or a methacrylic acid. Examples of the alkyl (meth)acrylate monomer include methyl (meth)acrylate, ethyl (meth)acrylate, n-propyl (meth)acrylate, sec-propyl (meth)acrylate, n-butyl (meth)acrylate, sec-butyl (meth)acrylate, tert-butyl (meth)acrylate, isoamyl (meth)acrylate, n-hexyl (meth)acrylate, cyclohexyl (meth)acrylate, n-octyl (meth)acrylate, isooctyl (meth)acrylate, 2-ethylhexyl (meth)acrylate, undecyl (meth)acrylate, and lauryl (meth)acrylate. The above-described alkyl (meth)acrylate is usually copolymerized at a ratio of 30 to 99.5 parts by mass in the acrylic adhesive.

Examples of the monomer having a carboxyl group forming an acrylic resin adhesive include a monomer containing a carboxyl group such as a (meth)acrylic acid, an itaconic acid, a crotonic acid, a maleic acid, a monobutyl maleate, and β-carboxy ethyl acrylate.

With the acrylic resin adhesive, a monomer having another functional group other than the above may be copolymerized as long as the property of the acrylic resin adhesive is not compromised. Examples of the monomer having another functional group include: a monomer having a functional group such as a monomer containing a hydroxyl group such as 2-hydroxyethyl (meth)acrylate, 2-hydroxy propyl (meth)acrylate, and allyl alcohol; a monomer containing an amide group such as (meth)acrylamide, N-methyl(meth)acrylamide, and N-ethyl (meth)acrylamide; a monomer containing a methylol group and an amide group such as N-methylol (meth)acrylamide and dimethylol (meth)acrylamide; a monomer containing an amino group such as aminomethyl (meth)acrylate, dimethylamino ethyl (meth)acrylate, and vinyl pyridine; a monomer containing an epoxy group such as allyl glycidyl ether, or (meth)acrylate glycidyl ether. Examples of the monomer having another functional group other than the above include fluorine substituted alkyl (meth)acrylate, (meth)acrylonitrile, an aromatic compound containing a vinyl group such as styrene and methyl styrene, vinyl acetate, a halogenated vinyl compound.

For the acrylic resin adhesive, other than the monomer having a functional group as described above, another monomer having an ethylenic double bond can be used. Examples of the monomer having an ethylenic double bond include a diester of an α,β-unsaturated dibasic acid such as dibutyl maleate, dioctyl maleate, or dibutyl fumarate; a vinyl ester such as vinyl acetate, vinyl propionate; vinyl ether; a vinyl aromatic compound such as styrene, α-methyl styrene, and vinyl toluene; and (meth)acrylonitrile. Other than the monomer having an ethylenic double bond as described above, a compound having two or more ethylenic double bonds may be used in combination. Examples of such a compound include divinylbenzene, diallyl maleate, diallyl phthalate, ethylene glycol di(meth)acrylate, trimethylol propane tri(meth)acrylate, and methylene bis(meth)acrylamide.

Further, other than the monomers as described above, a monomer having an alkoxy alkyl chain or the like can be used. Examples of the alkoxyalkyl (meth)acrylate include 2-methoxyethyl (meth)acrylate, methoxyethyl (meth)acrylate, 2-methoxypropyl (meth)acrylate, 3-methoxypropyl (meth)acrylate, 2-methoxybutyl (meth)acrylate, 4-methoxybutyl (meth)acrylate, 2-ethoxyethyl (meth)acrylate, 3-ethoxypropyl (meth)acrylate, and 4-ethoxybutyl (meth)acrylate.

As the adhesive composition, other than the above-described acrylic resin adhesive, a homopolymer of a alkyl (meth)acrylate monomer may also be used. Examples of the (meth)acrylate homopolymer include methyl poly(meth)acrylate, ethyl poly(meth)acrylate, propyl poly(meth)acrylate, butyl poly(meth)acrylate, and octyl poly(meth)acrylate. Examples of a copolymer containing two types of acrylic acid ester units include ethyl (meth)acrylate-methyl (meth)acrylate copolymer, butyl (meth)acrylate-methyl (meth)acrylate copolymer, 2-hydroxyethyl (meth)acrylate-methyl (meth)acrylate copolymer, and methyl (meth)acrylate-2-hydroxy 3-phenyloxypropyl (meth)acrylate copolymer. Examples of a copolymer of a (meth)acrylic ester and another functional monomer include a methyl (meth)acrylate-styrene copolymer, a methyl (meth)acrylate-ethylene copolymer, and a methyl (meth)acrylate-2-hydroxyethyl (meth)acrylate-styrene copolymer.

For the adhesive, those commercially available may be used, and examples thereof include SK-Dyne 2094, SK-Dyne 2147, SK-Dyne 1811L, SK-Dyne 1442, SK-Dyne 1435, and SK-Dyne 1415 (manufactured by Soken Chemical & Engineering Co., Ltd.), Oribain EG-655, and Oribain BPS5896 (manufactured by TOYO INK CO., LTD.) or the like (trade name), which can be suitably used.

### (Reflection Protection Layer)

A reflection protection layer is a layer for preventing a reflection or a reflection of an external light on the outermost surface of the transparent sheet or a layered body thereof. The reflection protection layer may be layered on the front side (the viewer side) of the transparent sheet or the layered body thereof or may be layered on both sides thereof. Especially when such sheet is used as a transparent screen, the reflection protection layer is preferably layered on the viewer side. The reflection protection layer is preferably formed by using a resin which does not compromise the transmission visibility or a desired optical property of the transparent sheet or the layered body thereof. For such a resin, for example, a resin cured by an ultraviolet light/electron beam, i.e., an ionizing radiation-curable resin, those obtained by mixing a thermoplastic resin and a solvent to an ionizing radiation-curable resin, and a thermoset resin can be used. Among these, an ionizing radiation-curable resin is particularly preferable.

A method of forming the reflection protection layer is not particularly limited, and a dry coating method such as pasting of a coating film, or direct deposition or sputtering on a film substrate; and a wet coating treatment method such as gravure coating, microgravure coating, bar coating, slide die coating, slot die coating, and dip coating may be used.

### <Method for Manufacturing Transparent Sheet>

A method for manufacturing a transparent sheet according to the present invention comprises a forming step of an optical diffusion layer. The forming step of the optical diffusion layer is a step in which molding can be processed according to known methods such as extrusion molding comprising kneading and film manufacturing process, injection molding, calendering molding, blow, compression molding, continuous casting, and cell casting method. In view of the wide range of the film thickness that can be manufactured, extrusion molding method can be suitably used. Additionally, in view of the formability of the thick film sheet, continuous casting, cell casting, and injection molding method can be suitably used. In the following, each step of the manufacturing method will be described in details.

### (Kneading Process)

A kneading process can be performed by using a single- or a twin-screw kneading extruder. When a twin-screw kneading extruder is used, preferably, the resin and the microparticles as above are kneaded while applying a shear stress, preferably from 3 to 1,800 KPa, more preferably from 6 to 1,400 KPa on average over the whole length of a screw to obtain a resin composition. When the shear stress is within the above-described range, the microparticles can be sufficiently dispersed in the resin. In particular, when the shear stress is 3 KPa or higher, the dispersion homogeneity of the microparticles can be more improved, and when the the shear stress is 1,800 KPa or less, degradation of the resin is prevented, thereby preventing contamination of an air bubble in the optical diffusion layer. The shear stress can be set in a desired range by regulating the twin-screw kneading extruder. In the present invention, a resin (master batch) to which microparticles are added in advance and a resin to which microparticles are not added may be mixed together to be kneaded by a twin-screw kneading extruder, thereby obtaining a resin composition.

To the resin composition, other than the resin and the microparticles, conventionally known additives may be added as long as the transmission visibility or a desired optical performance of the transparent sheet is not compromised. Examples of the additives include an antioxidant, a lubricant, an ultraviolet absorber, a compatibilizer, a nucleating agent, and a stabilizer. The resin and the microparticles are as described above.

A twin-screw kneading extruder used in the kneading process comprises a cylinder and two screws therein and is configured by combining screw elements. For the screw, a flight screw at least including a conveying element and a kneading element is suitably used. The kneading element preferably includes at least one selected from the group consisting of a kneading element, a mixing element, and a rotary element. By using such flight screw including a kneading element, the microparticles can be sufficiently dispersed in the resin while applying a desired shear stress.

### (Film Manufacturing Process)

A film manufacturing process is a process in which the resin composition obtained in the kneading process is manufactured to a film. A film manufacturing method is not particularly limited, and a film consisted of a resin composition can be made by a conventionally known method. For example, the resin composition obtained in the kneading process is provided to a melt extruder heated to a temperature (Tm to Tm+70° C.) of the melting point or higher to melt the resin composition. For the melt extruder, a single-screw extruder, a twin-screw extruder, a vent extruder, or a tandem extruder can be used depending on the purposes.

Subsequently, the molten resin composition is, for example, extruded into a sheet form by a die such as a T-die, and the extruded sheet-form article is rapidly quenched and solidified by a revolving cooling drum or the like, thereby forming a flim. When the film manufacturing process is performed continuously with the above-described kneading process, the resin composition obtained in the kneading process in a molten state may be directly extruded into a sheet-form with a die to give an optical diffusion layer in a film-form. Depending on the thickness, an injection molding machine (e.g. Trade Name: FNX-III; manufactured by Nissei Plastic Industrial Co., Ltd.) or cell casting method can be suitably used. The cell casting method is a method in which a monomer is enclosed in between 2 glass plates and polymerization is performed therein, and continuous casting method is a method in which 2 continuous mirror surface stainless belts are arranged one above the other, and a monomer is run in between the belts to polymerize. The optical diffusion layer (sheet) can be made by using the cell casting or the continuous casting method, by dispersing the microparticles to the monomers before polymerization.

The optical diffusion layer in film-form, obtained in the film manufacturing process, can be further uniaxially or biaxially stretched by a conventionally known method. Stretching of the above-described optical diffusion layer can improve the strength of the optical diffusion layer.

### <Transparent Screen>

The transparent screen according to the present invention comprises the transparent sheet described above. The transparent screen may only comprise the transparent sheet described above, or may further comprise a support such as a transparent partition. The transparent screen may be planar, curved, or may have a concave-convex surface.

The transparent screen may be a back projection type screen (a transmission type screen) or may be a front projection type screen (a reflection type screen). That means, in an image display apparatus comprising the transparent screen according to the present invention, a light source may be positioned on the viewer side with respect to the screen or may be positioned on the opposite side of the viewer.

### (Support)

A support is for supporting the transparent sheet. Any support may be used as long as it does not compromise the transmission visibility or a desired optical property of the transparent screen, and examples thereof include a transparent partition, a glass window, a head-up display for a vehicle, and a wearable display, etc.

### <Member for Vehicle>

A member for a vehicle according to the present invention comprises the transparent sheet or the transparent screen as described above and may be a layered body which further comprises a reflection protection layer or the like. Examples of the member for a vehicle include a windshield or a side glass. When the member for a vehicle comprises the transparent sheet or the transparent screen described above, a clear image can be displayed on the member for a vehicle without providing a separate screen.

### <Member for House>

A member for a house according to the present invention comprises the transparent sheet or the transparent screen described above and may be a layered body which further comprises a reflection protection layer or the like. Examples of the member for a house include a window glass for a house, a glass wall for a convenient store or a shop along the street. When the member for a house comprises the transparent sheet or the transparent screen described above, a clear image can be displayed on the member for a house without providing a separate screen.

### <Image Projection Device>

An image projection device according to the present invention comprises the transparent sheet or the transparent screen described above and a projection device. The projection device is not particularly limited, as long as the device can project an image on a screen, and for example, a commercially available rear or front projector can be used.

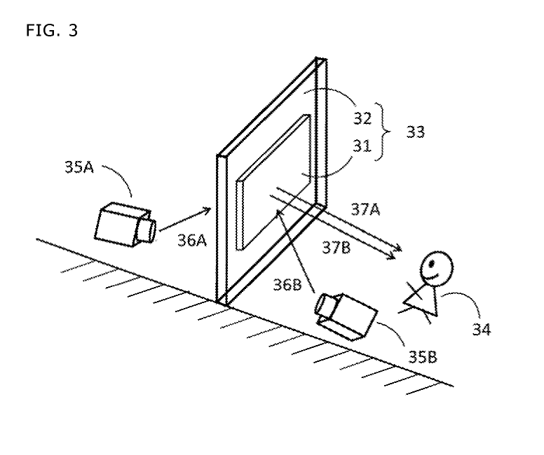

FIG. 3 is a schematic diagram illustrating one embodiment of a transparent screen and an image projection device according to the present invention. A transparent screen 33 comprises a transparent partition (a support) 32 and a transparent sheet 31 at a viewer 34 side on the transparent partition 31. The transparent sheet 31 may include an adhesive layer to stick to the transparent partition 32. In case of a back projection screen, the image projection device comprises the transparent screen 33 and a projection device 35A provided on the opposite side (the back side) of the viewer 34 with respect to the transparent partition 31. A projection light 36A emitted from the projection device 35A enters from the back side of the transparent screen 33 and anisotropically diffuses by the transparent screen 33, whereby the viewer 34 can visually recognize a diffused light 37A. On the other hand, in case of a front projection screen, the image projection device comprises the transparent screen 33 and a projection device 35B provided on the same side (the front side) of the viewer 34 with respect to the transparent partition 31. A projection light 36B emitted from the projection device 35B enters from the front side of the transparent screen 33 and anisotropically diffuses by the transparent screen 33, whereby the viewer 34 can visually recognize a diffused light 37B.

### EXAMPLES

In the following, the present invention will be more specifically described with reference to Examples and Comparative Examples, but the present invention should not be construed to be limited to the following Examples.

The measuring methods of various physicalities and performance evaluation in the Examples and the Comparative Examples are as follows.

### (1) Haze

Haze was measured by using a turbidimeter (Part No.: NDH-5000; manufactured by NIPPON DENSHOKU INDUSTRIES CO., LTD.) in accordance with JIS K 7136.

### (2) Diffusion Transmittance

Diffusion transmittance was measured by using a turbidimeter (Part No.: NDH-5000; manufactured by NIPPON DENSHOKU INDUSTRIES CO., LTD.) in accordance with JIS K 7136

### (3) Total Light Transmittance

Total light transmittance was measured by using a turbidimeter (Part No.: NDH-5000; manufactured by NIPPON DENSHOKU INDUSTRIES CO., LTD.) in accordance with JIS K 7361-1.

### (4) Frontal Luminous Intensity

Frontal luminous intensity was measured by using a goniophotometer (Part No.: GC5000L; manufactured by NIPPON DENSHOKU INDUSTRIES CO., LTD.).

An entering angle of a light source was set to 0 degree, and a transmitted light intensity in the direction of 0 degree with nothing placed on the measuring stage was 100. When a sample was measured, the entering angle of the light source was set to 15 degrees, corresponding to a set angle of a common projector, and the intensity of the transmitted light in the direction of 0 degree was measured.

### (5) Viewing Angle

Viewing angle was measured by using a goniophotometer (Part No.: GC5000L; manufactured by NIPPON DENSHOKU INDUSTRIES CO., LTD.).

An entering angle of a light source was set to 0 degree, and a transmitted light intensity in the direction of 0 degree with nothing placed on the measuring stage was 100. When a sample was measured, the transmitted light intensity was measured by 1 degree from −85 degrees to +85 degrees with the entering angle of the light source kept at 0 degree. Among the measured range, the range having the transmitted light intensity of 0.001 or higher was the viewing angle.

### (5) Image Clarity

Image clarity is a value of definition (%) when measured by using an image clarity measuring device (Part No.: ICM-IT; manufactured by Suga Test Instruments Co., Ltd.), with an optical comb having a width of 0.125 mm in accordance with JIS K7374. The larger the value of the definition, the higher is the transmission image clarity.

### (6) Image Visibility

An image was projected on the sheet made as a transparent screen as described below by using a mobile LED mini projector PP-D1S, manufactured by Onkyo Digital Solutions Corporation, from a position 50 cm away in an angle of 15 degrees against a normal line direction. Then, after adjusting a focus knob of the projector to bring focus on the screen surface, the image displayed on the screen was visually evaluated from 2 positions: 1 m frontward from the screen (the same side as the projector against the screen; so-called a front projection); and 1 m backward from the screen (the opposite side of the projector against the screen; so-called a rear projection), under the following evaluation criteria. Performance as a reflection type screen can be evaluated by observing from the front of the screen and performance as a transmission type screen can be evaluated by observing from the back of the screen.

### [Evaluation Criteria]

⊚: A significantly clear image was visualized

◯: A clear image was visualized

Δ: An image was visualized but dark

x: No image was visualized

### Example 1

(1A) Manufacturing of Thermoplastic Resin Pellet to which Microparticles are Added (Hereinafter Referred to as “Manufacturing Process of Pellet”)

For a thermoplastic resin pellet, a polyethylene terephthalate resin (PET) pellet (Trade Name: IP121B; manufactured by Bell Polyester Products, Inc.) was prepared. To this PET pellet, 0.3% by mass of ZrO₂ particles (median diameter of the primary particles: 10 nm; manufactured by Kanto Denka Kogyo Co., Ltd.), based on the PET pellet, were added as inorganic microparticles and was mixed with a rotating mixer to obtain a PET pellet in which the ZrO₂ particles are uniformly adhered to the surface of the PET pellet. This pellet was introduced into a hopper of a twin-screw kneading extruder (Trade Name: KZW-30MG; manufactured by TECHNOVEL CORPORATION), and a strand obtained by melt kneading at 270° C. was pelletized to obtain a PET pellet which 0.3% by mass of ZrO₂ particles are blended therein.

### (2A) Manufacturing of Optical Diffusion Layer (Sheet) (Hereinafter Referred to as “Manufacturing Process of Sheet”)

An optical diffusion layer (sheet) in a thickness of 1 mm (1000 μm) was made with an injection molding machine (Trade Name: FNX-III; manufactured by Nissei Plastic Industrial Co., Ltd.), using the ZrO₂ contained pellet of the above-described (1A).

### (3A) Evaluation of Transparent Screen

When the optical diffusion layer (sheet) as made was used directly as the transparent screen, the haze value was 57.5%, the diffusion transmittance was 47.2%, the total light transmission was 82%, and the transparency was sufficient, although slightly inferior to Example 7.

The frontal luminous intensity (×1000) measured with the goniophometer was 14.0, which was found to result in excellent frontal luminous intensity. The viewing angle measured with the goniophometer was ±44 degrees, which was found to result in excellent viewing angle property. The image clarity was 85%, and the image seen transmitted through the transparent screen was clear. Upon visually evaluating the visibility, the image was able to be clearly visualized.

### Example 2

An optical diffusion layer (sheet) was made in the same manner as Example 1, except that the thickness of the optical diffusion layer (sheet) was changed to 2 mm (2000 μm) in the manufacturing process of the sheet (2A).

When the optical diffusion layer (sheet) as made was used directly as the transparent screen, the haze value was 76.7%, the diffusion transmittance was 56.8%, the total light transmission was 74%, and the transparency was sufficient, although slightly inferior to Example 8.

The frontal luminous intensity (×1000) measured with the goniophometer was 14.3, which was found to result in excellent frontal luminous intensity. The viewing angle measured with the goniophometer was ±53 degrees, which was found to result in excellent viewing angle property. The image clarity was 82%, and the image seen transmitted through the transparent screen was clear. Upon visually evaluating the visibility, the image was able to be clearly visualized.

### Example 3

An optical diffusion layer (sheet) was made in the same manner as Example 1, except that the thickness of the optical diffusion layer (sheet) was changed to 3 mm (3000 μm) in the manufacturing process of the sheet (2A).

When the optical diffusion layer (sheet) as made was used directly as the transparent screen, the haze value was 83.8%, the diffusion transmittance was 58.7%, the total light transmission was 70%, and the transparency was sufficient, although slightly inferior to Example 9.

The frontal luminous intensity (×1000) measured with the goniophometer was 14.6, which was found to result in excellent frontal luminous intensity. The viewing angle measured with the goniophometer was ±60 degrees, which was found to result in excellent viewing angle property. The image clarity was 80%, and the image seen transmitted through the transparent screen was clear. Upon visually evaluating the visibility, the image was able to be clearly visualized.

### Example 4

An optical diffusion layer (sheet) was made in the same manner as Example 1, except that the added amount of ZrO₂ was changed to 0.15% by mass in the Manufacturing Process of Pellet (1A).

When the optical diffusion layer (sheet) as made was used directly as the transparent screen, the haze value was 37.6%, the diffusion transmittance was 32.0%, the total light transmission was 85%, and the transparency was sufficient, although slightly inferior to Example 7.

The frontal luminous intensity (×1000) measured with the goniophometer was 9.8, which was found to result in excellent frontal luminous intensity. The viewing angle measured with the goniophometer was ±36 degrees, which was found to result in excellent viewing angle property. The image clarity was 89%, and the image seen transmitted through the transparent screen was clear. Upon visually evaluating the visibility, the image was able to be clearly visualized.

### Example 5

An optical diffusion layer (sheet) was made in the same manner as Example 2, except that the added amount of ZrO₂ was changed to 0.15% by mass in the Manufacturing Process of Pellet (1A).

When the optical diffusion layer (sheet) as made was used directly as the transparent screen, the haze value was 58.6%, the diffusion transmittance was 48.1%, the total light transmission was 82%, and the transparency was sufficient, although slightly inferior to Example 8.

The frontal luminous intensity (×1000) measured with the goniophometer was 12.9, which was found to result in excellent frontal luminous intensity. The viewing angle measured with the goniophometer was ±44 degrees, which was found to result in excellent viewing angle property. The image clarity was 88%, and the image seen transmitted through the transparent screen was clear. Upon visually evaluating the visibility, the image was able to be clearly visualized.

### Example 6

An optical diffusion layer (sheet) was made in the same manner as Example 3, except that the added amount of ZrO₂ was changed to 0.15% by mass in the Manufacturing Process of Pellet (1A).

When the optical diffusion layer (sheet) as made was used directly as the transparent screen, the haze value was 70.0%, the diffusion transmittance was 53.9%, the total light transmission was 77%, and the transparency was sufficient, although slightly inferior to Example 9.

The frontal luminous intensity (×1000) measured with the goniophometer was 16.3, which was found to result in excellent frontal luminous intensity. The viewing angle measured with the goniophometer was ±52 degrees, which was found to result in excellent viewing angle property. The image clarity was 86%, and the image seen transmitted through the transparent screen was clear. Upon visually evaluating the visibility, the image was able to be clearly visualized.

### Example 7

An optical diffusion layer (sheet) was made in the same manner as Example 1, except that the added amount of ZrO₂ was changed to 0.02% by mass in the Manufacturing Process of Pellet (1A).

When the optical diffusion layer (sheet) as made was used directly as the transparent screen, the haze value was 7.7%, the diffusion transmittance was 6.8%, the total light transmission was 88%, and the transparency was sufficient. The frontal luminous intensity (×1000) measured with the goniophometer was 3.1, which was found to result in excellent frontal luminous intensity. The viewing angle measured with the goniophometer was ±20 degrees, which was found to result in excellent viewing angle property. The image clarity was 89%, and the image seen transmitted through the transparent screen was clear. Upon visually evaluating the visibility, the image was able to be clearly visualized, although inferior to Example 1.

### Example 8

An optical diffusion layer (sheet) was made in the same manner as Example 2, except that the added amount of ZrO₂ was changed to 0.02% by mass in the Manufacturing Process of Pellet (1A).

When the optical diffusion layer (sheet) as made was used directly as the transparent screen, the haze value was 12.9%, the diffusion transmittance was 11.2%, the total light transmission was 87%, and the transparency was sufficient.

The frontal luminous intensity (×1000) measured with the goniophometer was 3.7, which was found to result in excellent frontal luminous intensity. The viewing angle measured with the goniophometer was ±21 degrees, which was found to result in excellent viewing angle property. The image clarity was 88%, and the image seen transmitted through the transparent screen was clear. Upon visually evaluating the visibility, the image was able to be clearly visualized.

### Example 9

An optical diffusion layer (sheet) was made in the same manner as Example 3, except that the added amount of ZrO₂ was changed to 0.02% by mass in the Manufacturing Process of Pellet (1A).

When the optical diffusion layer (sheet) as made was used directly as the transparent screen, the haze value was 16.7%, the diffusion transmittance was 14.4%, the total light transmission was 86%, and the transparency was sufficient.

The frontal luminous intensity (×1000) measured with the goniophometer was 4.0, which was found to result in excellent frontal luminous intensity. The viewing angle measured with the goniophometer was ±26 degrees, which was found to result in excellent viewing angle property. The image clarity was 86%, and the image seen transmitted through the transparent screen was clear. Upon visually evaluating the visibility, the image was able to be clearly visualized.

### Example 10

An optical diffusion layer (sheet) was made in the same manner as Example 1, except that the added amount of ZrO₂ was changed to 0.01% by mass in the Manufacturing Process of Pellet (1A).

When the optical diffusion layer (sheet) as made was used directly as the transparent screen, the haze value was 4.1%, the diffusion transmittance was 3.6%, the total light transmission was 88%, and the transparency was sufficient.

The frontal luminous intensity (×1000) measured with the goniophometer was 2.3, which was found to result in excellent frontal luminous intensity. The viewing angle measured with the goniophometer was ±11 degrees, which was found to result in excellent viewing angle property. The image clarity was 89%, and the image seen transmitted through the transparent screen was clear. Upon visually evaluating the visibility, the image was able to be clearly visualized, although inferior to Example 1.

### Example 11

An optical diffusion layer (sheet) was made in the same manner as Example 2, except that the added amount of ZrO₂ was changed to 0.01% by mass in the Manufacturing Process of Pellet (1A).

When the optical diffusion layer (sheet) as made was used directly as the transparent screen, the haze value was 6.8%, the diffusion transmittance was 5.9%, the total light transmission was 87%, and the transparency was sufficient.

The frontal luminous intensity (×1000) measured with the goniophometer was 2.4, which was found to result in excellent frontal luminous intensity. The viewing angle measured with the goniophometer was ±16 degrees, which was found to result in excellent viewing angle property. The image clarity was 88%, and the image seen transmitted through the transparent screen was clear. Upon visually evaluating the visibility, the image was able to be clearly visualized.

### Example 12

An optical diffusion layer (sheet) was made in the same manner as Example 3, except that the added amount of ZrO₂ was changed to 0.01% by mass in the Manufacturing Process of Pellet (1A).

When the optical diffusion layer (sheet) as made was used directly as the transparent screen, the haze value was 8.4%, the diffusion transmittance was 7.3%, the total light transmission was 87%, and the transparency was sufficient. The frontal luminous intensity (×1000) measured with the goniophometer was 2.8, which was found to result in excellent frontal luminous intensity. The viewing angle measured with the goniophometer was ±19 degrees, which was found to result in excellent viewing angle property. The image clarity was 88%, and the image seen transmitted through the transparent screen was clear. Upon visually evaluating the visibility, the image was able to be clearly visualized.

### Example 13

An optical diffusion layer (sheet) was made in the same manner as Example 1, except that the added amount of ZrO₂ was changed to 0.006% by mass in the Manufacturing Process of Pellet (1A).

When the optical diffusion layer (sheet) as made was used directly as the transparent screen, the haze value was 2.5%, the diffusion transmittance was 2.2%, the total light transmission was 88%, and the transparency was sufficient.

The frontal luminous intensity (×1000) measured with the goniophometer was 1.0, which was found to result in excellent frontal luminous intensity. The viewing angle measured with the goniophometer was ±8 degrees, which was found to result in slightly less excellent viewing angle property. The image clarity was 89%, and the image seen transmitted through the transparent screen was clear. Upon visually evaluating the visibility, the image was able to be clearly visualized.

### Example 14

An optical diffusion layer (sheet) was made in the same manner as Example 2, except that the added amount of ZrO₂ was changed to 0.006% by mass in the Manufacturing Process of Pellet (1A).

When the optical diffusion layer (sheet) as made was used directly as the transparent screen, the haze value was 4.4%, the diffusion transmittance was 3.9%, the total light transmission was 88%, and the transparency was sufficient.

The frontal luminous intensity (×1000) measured with the goniophometer was 1.1, which was found to result in excellent frontal luminous intensity. The viewing angle measured with the goniophometer was ±10 degrees, which was found to result in excellent viewing angle property. The image clarity was 89%, and the image seen transmitted through the transparent screen was clear. Upon visually evaluating the visibility, the image was able to be clearly visualized.

### Example 15

An optical diffusion layer (sheet) was made in the same manner as Example 3, except that the added amount of ZrO₂ was changed to 0.006% by mass in the Manufacturing Process of Pellet (1A).

When the optical diffusion layer (sheet) as made was used directly as the transparent screen, the haze value was 4.7%, the diffusion transmittance was 4.1%, the total light transmission was 88%, and the transparency was sufficient.

The frontal luminous intensity (×1000) measured with the goniophometer was 1.2, which was found to result in excellent frontal luminous intensity. The viewing angle measured with the goniophometer was ±13 degrees, which was found to result in excellent viewing angle property. The image clarity was 88%, and the image seen transmitted through the transparent screen was clear. Upon visually evaluating the visibility, the image was able to be clearly visualized.

### Example 16

An optical diffusion layer (sheet) was made in the same manner as Example 1, except that the added amount of ZrO₂ was changed to 0.003% by mass in the Manufacturing Process of Pellet (1A).

When the optical diffusion layer (sheet) as made was used directly as the transparent screen, the haze value was 2.1%, the diffusion transmittance was 1.8%, the total light transmission was 88%, and the transparency was sufficient.

The frontal luminous intensity (×1000) measured with the goniophometer was 0.4, which was found to result in slightly less excellent frontal luminous intensity. The viewing angle measured with the goniophometer was ±8 degrees, which was found to result in slightly less excellent viewing angle property. The image clarity was 84%, and the image seen transmitted through the transparent screen was clear. Upon visually evaluating the visibility, the image was able to be clearly visualized, although inferior to Example 1.

### Example 17

An optical diffusion layer (sheet) was made in the same manner as Example 2, except that the added amount of ZrO₂ was changed to 0.003% by mass in the Manufacturing Process of Pellet (1A).

When the optical diffusion layer (sheet) as made was used directly as the transparent screen, the haze value was 2.9%, the diffusion transmittance was 2.6%, the total light transmission was 88%, and the transparency was sufficient.

The frontal luminous intensity (×1000) measured with the goniophometer was 0.4, which was found to result in slightly less excellent frontal luminous intensity. The viewing angle measured with the goniophometer was ±9 degrees, which was found to result in slightly less excellent viewing angle property. The image clarity was 83%, and the image seen transmitted through the transparent screen was clear. Upon visually evaluating the visibility, the image was able to be clearly visualized although inferior to Example 1.

### Example 18

An optical diffusion layer (sheet) was made in the same manner as Example 3, except that the added amount of ZrO₂ was changed to 0.003% by mass in the Manufacturing Process of Pellet (1A).

When the optical diffusion layer (sheet) as made was used directly as the transparent screen, the haze value was 2.8%, the diffusion transmittance was 2.4%, the total light transmission was 87%, and the transparency was sufficient.

The frontal luminous intensity (×1000) measured with the goniophometer was 0.5, which was found to result in excellent frontal luminous intensity. The viewing angle measured with the goniophometer was ±9 degrees, which was found to result in slightly less excellent viewing angle property. The image clarity was 89%, and the image seen transmitted through the transparent screen was clear. Upon visually evaluating the visibility, the image was able to be clearly visualized.

### Example 19

An optical diffusion layer (sheet) was made in the same manner as Example 1, except that the added amount of ZrO₂ was changed to 0.003% by mass in the Manufacturing Process of Pellet (1A), and the thickness of the optical diffusion layer (sheet) was changed to 1000 μm in the manufacturing process of the sheet (2A).

When the optical diffusion layer (sheet) as made was used directly as the transparent screen, the haze value was 3.2%, the diffusion transmittance was 2.8%, the total light transmission was 86%, and the transparency was sufficient.

The frontal luminous intensity (×1000) measured with the goniophometer was 0.6, which was found to result in excellent frontal luminous intensity. The viewing angle measured with the goniophometer was ±14 degrees, which was found to result in excellent viewing angle property. The image clarity was 85%, and the image seen transmitted through the transparent screen was clear. Upon visually evaluating the visibility, the image was able to be clearly visualized.

### Example 20

An optical diffusion layer (sheet) was made in the same manner as Example 19, except that the added amount of ZrO₂ was changed to 0.001% by mass in the Manufacturing Process of Pellet (1A).

When the optical diffusion layer (sheet) as made was used directly as the transparent screen, the haze value was 3.2%, the diffusion transmittance was 2.8%, the total light transmission was 86%, and the transparency was sufficient.

The frontal luminous intensity (×1000) measured with the goniophometer was 0.5, which was found to result in excellent frontal luminous intensity. The viewing angle measured with the goniophometer was ±12 degrees, which was found to result in excellent viewing angle property. The image clarity was 86%, and the image seen transmitted through the transparent screen was clear. Upon visually evaluating the visibility, the image was able to be clearly visualized, although inferior to Example 19.

### Example 21

An optical diffusion layer (sheet) was made in the same manner as Example 12, except that 0.01% by mass of barium titanate (BaTiO₂) particles (median diameter of the primary particles: 25 nm; manufactured by Kanto Denka Kogyo Co., Ltd.), based on the PET pellet, was added as inorganic microparticles in the Manufacturing Process of Pellet (1A).

When the optical diffusion layer (sheet) as made was used directly as the transparent screen, the haze value was 8.0%, the diffusion transmittance was 7.0%, the total light transmission was 87%, and the transparency was sufficient.

The frontal luminous intensity (×1000) measured with the goniophometer was 2.9, which was found to result in excellent frontal luminous intensity. The viewing angle measured with the goniophometer was ±20 degrees, which was found to result in excellent viewing angle property. The image clarity was 86%, and the image seen transmitted through the transparent screen was clear. Upon visually evaluating the visibility, the image was able to be clearly visualized.

### Example 22

An optical diffusion layer (sheet) was made in the same manner as Example 12, except that 0.01% by mass of titanium dioxide (TiO₂) particles (median diameter of the primary particles: 10 nm; manufactured by Kanto Denka Kogyo Co., Ltd.), based on the PET pellet, was added as inorganic microparticles in the Manufacturing Process of Pellet (1A).

When the optical diffusion layer (sheet) as made was used directly as the transparent screen, the haze value was 7.2%, the diffusion transmittance was 6.3%, the total light transmission was 87%, and the transparency was sufficient.

The frontal luminous intensity (×1000) measured with the goniophometer was 2.9, which was found to result in excellent frontal luminous intensity. The viewing angle measured with the goniophometer was ±19 degrees, which was found to result in excellent viewing angle property. The image clarity was 90%, and the image seen transmitted through the transparent screen was clear. Upon visually evaluating the visibility, the image was able to be clearly visualized.

### Example 23

An optical diffusion layer (sheet) was made in the same manner as Example 12, except that a polyethylene naphtalate (PEN) pellet (Trade Name: Teonex TN-8065S; manufactured by Teijin Limited) was used as a thermoplastic resin in the Manufacturing Process of Pellet (1A).

When the optical diffusion layer (sheet) as made was used directly as the transparent screen, the haze value was 7.9%, the diffusion transmittance was 6.6%, the total light transmission was 84%, and the transparency was sufficient.

The frontal luminous intensity (×1000) measured with the goniophometer was 2.7, which was found to result in excellent frontal luminous intensity. The viewing angle measured with the goniophometer was ±18 degrees, which was found to result in excellent viewing angle property. The image clarity was 86%, and the image seen transmitted through the transparent screen was clear. Upon visually evaluating the visibility, the image was able to be clearly visualized.

### Example 24

An optical diffusion layer (sheet) was made in the same manner as Example 12, except that a polycarbonate (PC) pellet (Trade Name: SD2201W; manufactured by Sumika Styron Polycarbonate Limited) was used as a thermoplastic resin in the Manufacturing Process of Pellet (1A).

When the optical diffusion layer (sheet) as made was used directly as the transparent screen, the haze value was 7.7%, the diffusion transmittance was 6.9%, the total light transmission was 89%, and the transparency was sufficient.

The frontal luminous intensity (×1000) measured with the goniophometer was 2.6, which was found to result in excellent frontal luminous intensity. The viewing angle measured with the goniophometer was ±19 degrees, which was found to result in excellent viewing angle property. The image clarity was 86%, and the image seen transmitted through the transparent screen was clear. Upon visually evaluating the visibility, the image was able to be clearly visualized.

### Example 25

An optical diffusion layer (sheet) was made in the same manner as Example 12, except that a polymethyl methacrylate (PMMA) pellet (Trade Name: ACRYPET VH; manufactured by Mitsubishi Rayon Co., Ltd.) was used as a thermoplastic resin in the Manufacturing Process of Pellet (1A).

When the optical diffusion layer (sheet) as made was used directly as the transparent screen, the haze value was 8.2%, the diffusion transmittance was 7.5%, the total light transmission was 92%, and the transparency was sufficient.

The frontal luminous intensity (×1000) measured with the goniophometer was 2.6, which was found to result in excellent frontal luminous intensity. The viewing angle measured with the goniophometer was ±15 degrees, which was found to result in excellent viewing angle property. The image clarity was 90%, and the image seen transmitted through the transparent screen was clear. Upon visually evaluating the visibility, the image was able to be clearly visualized.

### Example 26

An optical diffusion layer (sheet) was made in the same manner as Example 12, except that a polystyrene (PS) pellet (Brand Name: HF77; manufactured by PS Japan Corporation) was used as a thermoplastic resin in the Manufacturing Process of Pellet (1A).

When the optical diffusion layer (sheet) as made was used directly as the transparent screen, the haze value was 8.1%, the diffusion transmittance was 7.3%, the total light transmission was 90%, and the transparency was sufficient.

The frontal luminous intensity (×1000) measured with the goniophometer was 2.5, which was found to result in excellent frontal luminous intensity. The viewing angle measured with the goniophometer was ±15 degrees, which was found to result in excellent viewing angle property. The image clarity was 89%, and the image seen transmitted through the transparent screen was clear. Upon visually evaluating the visibility, the image was able to be clearly visualized.

### Example 27

2 glass plates with a smooth surface was opposed to one another and a flexible vinyl chloride gasket was provided peripherally such that the distance between both the glass plates were adjusted to 10 mm to form a casting mold.

A methyl methacrylate solution A by mixing 0.05% by mass of an ultraviolet absorber: 2-(5methyl-2-Hydroxylphenyl)benzotriazol), 0.003% by mass of ZrO₂ particles (median diameter of the primary particles: 10 nm; manufactured by Kanto Denka Kogyo Co., Ltd.), and 0.05% by mass of a polymerization initiator: 2,2-azobisisobutyronitrile, was injected into the casting mold and subsequently immersed for 6 hours in a bath of 65° C., heated for 6 hours in a circulating reactor, and the mixed solution was polymerized. Then, the polymer substance of the methyl methacrylate solution A was cooled, and both the glass plates were demolded to obtain an optical diffusion layer (sheet) in a film thickness of 10 mm (10000 μm).

When the optical diffusion layer (sheet) as made was used directly as the transparent screen, the haze value was 3.2%, the diffusion transmittance was 2.8%, the total light transmission was 88%, and the transparency was sufficient.

The frontal luminous intensity (×1000) measured with the goniophometer was 0.6, which was found to result in excellent frontal luminous intensity. The viewing angle measured with the goniophometer was ±18 degrees, which was found to result in excellent viewing angle property. The image clarity was 85%, and the image seen transmitted through the transparent screen was clear. Upon visually evaluating the visibility, the image was able to be clearly visualized.

### Comparative Example 1

(1B) Manufacturing of Thermoplastic Resin Pellet to which Microparticles are Added (Hereinafter Referred to as “Manufacturing Process of Pellet”)

For a thermoplastic resin pellet, a polyethylene terephthalate resin (PET) pellet (Trade Name: IP121B; manufactured by Bell Polyester Products, Inc.) was prepared. To this PET pellet, 0.3% by mass of zirconium oxide (ZrO₂) particles (median diameter of the primary particles: 10 nm; manufactured by Kanto Denka Kogyo Co., Ltd.), based on the PET pellet, were added as inorganic microparticles and was mixed with a rotating mixer to obtain a PET pellet in which the ZrO₂ particles are uniformly adhered to the surface of the PET pellet.

### (2B) Manufacturing of Optical Diffusion Layer (Film) (Hereinafter Referred to as “Manufacturing Process of the Film”)

The PET pellet added with the ZrO₂ particles of (1B) as above was introduced into a hopper of a twin-screw kneading extruder (Trade Name: KZW-30MG; manufactured by TECHNOVEL CORPORATION), and an optical diffusion layer (film) in a thickness of 150 μm was formed. The screw diameter of the twin-screw kneading extruder was 20 mm, and the active length (LID) of the screw was 30. A hangar coat type T-die was installed to the twin-screw kneading extruder through an adapter. The extrusion temperature was 270° C., the number of screw revolution was 500 rpm, and the sheer stress was 300 KPa. The used screw had the total length of 670 mm, comprised a mixing element in a portion between a position 160 mm and a position 185 mm from the hopper side of the screw and a kneading element in a portion between a position 185 mm and a position 285 mm from the hopper side of the screw, and other portions of the screw had a flight shape.

### (3B) Evaluation of Transparent Screen

When the optical diffusion layer (sheet) as made was used directly as the transparent screen, the haze value was 23.6%, the diffusion transmittance was 20.8%, the total light transmission was 88%, and the transparency was sufficient.

The frontal luminous intensity (×1000) measured with the goniophometer was 5.3, the viewing angle measured with the goniophometer was ±30 degrees, which each value was inferior to Examples 1 to 3. The image clarity was 86%, and the image seen transmitted through the transparent screen was clear. Upon visually evaluating the visibility, the image clarity was inferior to Examples 1 to 3.

### Comparative Example 2

An optical diffusion layer (film) was made in the same manner as Comparative Example 1, except that the added amount of ZrO₂ was changed to 0.15% by mass in the Manufacturing Process of Pellet (1B).

When the optical diffusion layer (film) as made was used directly as the transparent screen, the haze value was 13.0%, the diffusion transmittance was 11.4%, the total light transmission was 88%, and the transparency was sufficient.

The frontal luminous intensity (×1000) measured with the goniophometer was 3.0, the viewing angle measured with the goniophometer was ±20 degrees, which each value was inferior to Examples 4 to 6. The image clarity was 89%, and the image seen transmitted through the transparent screen was clear. Upon visually evaluating the visibility, the image clarity was inferior to Examples 4 to 6.

### Comparative Example 3

An optical diffusion layer (film) was made in the same manner as Comparative Example 1, except that the added amount of ZrO₂ was changed to 0.02% by mass in the Manufacturing Process of Pellet (1B).

When the optical diffusion layer (film) as made was used directly as the transparent screen, the haze value was 1.4%, the diffusion transmittance was 1.2%, the total light transmission was 88%, and the transparency was sufficient.

The frontal luminous intensity (×1000) measured with the goniophometer was 0.0, the viewing angle measured with the goniophometer was ±10 degrees, which each value was inferior to Examples 7 to 9. The image clarity was 89%, and the image seen transmitted through the transparent screen was clear. Upon visually evaluating the visibility, the image clarity was inferior to Examples 7 to 9.

### Comparative Example 4

An optical diffusion layer (film) was made in the same manner as Comparative Example 1, except that the added amount of ZrO₂ was changed to 0.01% by mass in the Manufacturing Process of Pellet (1B).

When the optical diffusion layer (film) as made was used directly as the transparent screen, the haze value was 0.7%, the diffusion transmittance was 0.6%, the total light transmission was 88%, and the transparency was sufficient.

The frontal luminous intensity (×1000) measured with the goniophometer was 0.0, the viewing angle measured with the goniophometer was ±7 degrees, which each value was inferior to Examples 10 to 12. The image clarity was 89%, and the image seen transmitted through the transparent screen was clear. Upon visually evaluating the visibility, the image clarity was inferior to Examples 10 to 12.

### Comparative Example 5

An optical diffusion layer (film) was made in the same manner as Comparative Example 1, except that the added amount of ZrO₂ was changed to 0.006% by mass in the Manufacturing Process of Pellet (1B).

When the optical diffusion layer (film) as made was used directly as the transparent screen, the haze value was 0.5%, the diffusion transmittance was 0.4%, the total light transmission was 88%, and the transparency was sufficient. The frontal luminous intensity (×1000) measured with the goniophometer was 0.0, the viewing angle measured with the goniophometer was ±6 degrees, which each value was inferior to Examples 13 to 15. The image clarity was 90%, and the image seen transmitted through the transparent screen was clear. Upon visually evaluating the visibility, the image clarity was inferior to Examples 13 to 15.

### Comparative Example 6

An optical diffusion layer (film) was made in the same manner as Comparative Example 1, except that the added amount of ZrO₂ was changed to 0.003% by mass in the Manufacturing Process of Pellet (1B).

When the optical diffusion layer (film) as made was used directly as the transparent screen, the haze value was 0.4%, the diffusion transmittance was 0.4%, the total light transmission was 88%, and the transparency was sufficient.

The frontal luminous intensity (×1000) measured with the goniophometer was 0.0, the viewing angle measured with the goniophometer was ±5 degrees, which each value was inferior to Examples 16 to 19. The image clarity was 90%, and the image seen transmitted through the transparent screen was clear. Upon visually evaluating the visibility, the image clarity was inferior to Examples 16 to 19.

### Comparative Example 7

An optical diffusion layer (film) was made in the same manner as Comparative Example 1, except that the added amount of ZrO₂ was changed to 0.001% by mass in the Manufacturing Process of Pellet (1B).

When the optical diffusion layer (film) as made was used directly as the transparent screen, the haze value was 0.4%, the diffusion transmittance was 0.4%, the total light transmission was 88%, and the transparency was sufficient.

The frontal luminous intensity (×1000) measured with the goniophometer was 0.0, the viewing angle measured with the goniophometer was ±5 degrees, which each value was inferior to Example 20. The image clarity was 88%, and the image seen transmitted through the transparent screen was clear. Upon visually evaluating the visibility, the image clarity was inferior to Example 20.

### Comparative Example 8

An optical diffusion layer (film) was made in the same manner as Example 12, except that 0.01% by mass of barium titanate (BaTiO₂) particles (median diameter of the primary particles: 25 nm; manufactured by Kanto Denka Kogyo Co.,

Ltd.), based on the PET pellet, was added as inorganic microparticles in the Manufacturing Process of Pellet (1B), and the film thickness of the optical diffusion layer (film) was changed to 100 μm in the manufacturing process of the sheet (2B).

When the optical diffusion layer (film) as made was used directly as the transparent screen, the haze value was 0.7%, the diffusion transmittance was 0.6%, the total light transmission was 88%, and the transparency was sufficient. The frontal luminous intensity (×1000) measured with the goniophometer was 0.0, the viewing angle measured with the goniophometer was ±8 degrees, which each value was inferior to Example 21. The image clarity was 86%, and the image seen transmitted through the transparent screen was clear. Upon visually evaluating the visibility, the image clarity was inferior to Example 21.

### Comparative Example 8

An optical diffusion layer (film) was made in the same manner as Comparative Example 1, except that 0.01% by mass of barium titanate (BaTiO₂) particles (median diameter of the primary particles: 25 nm; manufactured by Kanto Denka Kogyo Co., Ltd.), based on the PET pellet, was added as inorganic microparticles in the Manufacturing Process of Pellet (1B), and the thickness of the optical diffusion layer (film) was changed to 100 μm in the manufacturing process of the sheet (2B).

When the optical diffusion layer (film) as made was used directly as the transparent screen, the haze value was 0.7%, the diffusion transmittance was 0.6%, the total light transmission was 88%, and the transparency was sufficient. The frontal luminous intensity (×1000) measured with the goniophometer was 0.0, the viewing angle measured with the goniophometer was ±8 degrees, which each value was inferior to Example 21. The image clarity was 86%, and the image seen transmitted through the transparent screen was clear. Upon visually evaluating the visibility, the image clarity was inferior to Example 21.

### Comparative Example 9

An optical diffusion layer (film) was made in the same manner as Comparative Example 8, except that 0.01% by mass of titanium dioxide (TiO₂) particles (median diameter of the primary particles: 10 nm; manufactured by Kanto Denka Kogyo Co., Ltd.), based on the PET pellet, was added as inorganic microparticles in the Manufacturing Process of Pellet (1B). When the optical diffusion layer (film) as made was used directly as the transparent screen, the haze value was 0.7%, the diffusion transmittance was 0.6%, the total light transmission was 88%, and the transparency was sufficient.

The frontal luminous intensity (×1000) measured with the goniophometer was 0.0, the viewing angle measured with the goniophometer was ±8 degrees, which each value was inferior to Example 22. The image clarity was 87%, and the image seen transmitted through the transparent screen was clear. Upon visually evaluating the visibility, the image clarity was inferior to Example 22.

### Comparative Example 10

An optical diffusion layer (film) was made in the same manner as Comparative Example 4, except that a polyethylene naphtalate (PEN) pellet (Trade Name: Teonex TN-8065S; manufactured by Teijin Limited) was used as a thermoplastic resin in the Manufacturing Process of Pellet (1B), and the thickness of the optical diffusion layer (film) was changed to 100 μm in the manufacturing process of the sheet (2B).

When the optical diffusion layer (film) as made was used directly as the transparent screen, the haze value was 0.8%, the diffusion transmittance was 0.7%, the total light transmission was 84%, and the transparency was sufficient.

The frontal luminous intensity (×1000) measured with the goniophometer was 0.0, the viewing angle measured with the goniophometer was ±7 degrees, which each value was inferior to Example 23. The image clarity was 88%, and the image seen transmitted through the transparent screen was clear. Upon visually evaluating the visibility, the image clarity was inferior to Example 23.

### Comparative Example 11

An optical diffusion layer (film) was made in the same manner as Comparative Example 4, except that a polycarbonate (PC) pellet (Trade Name: SD2201W; manufactured by Sumika Styron Polycarbonate Limited) was used as a thermoplastic resin in the Manufacturing Process of Pellet (1B), and the thickness of the optical diffusion layer (film) was changed to 100 μm in the manufacturing process of the sheet (2B).

When the optical diffusion layer (film) as made was used directly as the transparent screen, the haze value was 0.7%, the diffusion transmittance was 0.6%, the total light transmission was 90%, and the transparency was sufficient.

The frontal luminous intensity (×1000) measured with the goniophometer was 0.0, the viewing angle measured with the goniophometer was ±6 degrees, which each value was inferior to Example 24. The image clarity was 89%, and the image seen transmitted through the transparent screen was clear. Upon visually evaluating the visibility, the image clarity was inferior to Example 24.

### Comparative Example 12

An optical diffusion layer (film) was made in the same manner as Comparative Example 3, except that a polymethyl methacrylate (PMMA) pellet (Trade Name: ACRYPET VH; manufactured by Mitsubishi Rayon Co., Ltd.) was used as a thermoplastic resin in the Manufacturing Process of Pellet (1B), and the thickness of the optical diffusion layer (film) was changed to 100 μm in the manufacturing process of the sheet (2B).

When the optical diffusion layer (film) as made was used directly as the transparent screen, the haze value was 0.7%, the diffusion transmittance was 0.7%, the total light transmission was 92%, and the transparency was sufficient.

The frontal luminous intensity (×1000) measured with the goniophometer was 0.0, the viewing angle measured with the goniophometer was ±8 degrees, which each value was inferior to Example 25. The image clarity was 86%, and the image seen transmitted through the transparent screen was clear. Upon visually evaluating the visibility, the image clarity was inferior to Example 25.

### Comparative Example 13

An optical diffusion layer (film) was made in the same manner as Comparative Example 4, except that a polystyrene (PS) pellet (Brand Name: HF77; manufactured by PS Japan Corporation) was used as a thermoplastic resin in the Manufacturing Process of Pellet (1B), and the thickness of the optical diffusion layer (film) was changed to 100 μm in the manufacturing process of the sheet (2B).

When the optical diffusion layer (film) as made was used directly as the transparent screen, the haze value was 0.7%, the diffusion transmittance was 0.6%, the total light transmission was 90%, and the transparency was sufficient.

The frontal luminous intensity (×1000) measured with the goniophometer was 0.0, the viewing angle measured with the goniophometer was ±9 degrees, which each value was inferior to Example 26. The image clarity was 82%, and the image seen transmitted through the transparent screen was clear. Upon visually evaluating the visibility, the image clarity was inferior to Example 26.

### Comparative Example 14

An optical diffusion layer (film) was made in the same manner as Comparative Example 1, except that the added amount of ZrO₂ was changed to 0.00005% by mass in the Manufacturing Process of Pellet (1B), and the thickness of the optical diffusion layer (film) was changed to 200 μm in the manufacturing process of the sheet (2B).

When the optical diffusion layer (film) as made was used directly as the transparent screen, the haze value was 0.3%, the diffusion transmittance was 0.3%, the total light transmission was 88%, and the transparency was sufficient.

The frontal luminous intensity (×1000) measured with the goniophometer was 0.2, the viewing angle measured with the goniophometer was ±3 degrees, which each value was inferior to Examples 1 to 3. The image clarity was 92%, and the image seen transmitted through the transparent screen was clear. Upon visually evaluating the visibility, the image clarity was inferior to Examples 1 to 3.

The details of the optical diffusion layers used in the Examples and the Comparative Examples are shown in Table 1.

TABLE 1

| | Optical diffusion layer | | | | | |
|---|---|---|---|---|---|---|
| | | | | | Concentration | |
| | Type | Refractive | Type of | Refractive | of | |
| | of | index | micro- | index | microparticles | |
| | Resin | n₁ [—] | particles | n₂ [—] | [wt %] | Thickness [μm] |
| Comparative | PET | 1.68 | ZrO₂ | 2.40 | 0.3 | 150 |
| Example 1 | | | | | | |
| Example 1 | PET | 1.68 | ZrO₂ | 2.40 | 0.3 | 1000 |
| Example 2 | PET | 1.68 | ZrO₂ | 2.40 | 0.3 | 2000 |
| Example 3 | PET | 1.68 | ZrO₂ | 2.40 | 0.3 | 3000 |
| Comparative | PET | 1.68 | ZrO₂ | 2.40 | 0.15 | 150 |
| Example 2 | | | | | | |
| Example 4 | PET | 1.68 | ZrO₂ | 2.40 | 0.15 | 1000 |
| Example 5 | PET | 1.68 | ZrO₂ | 2.40 | 0.15 | 2000 |
| Example 6 | PET | 1.68 | ZrO₂ | 2.40 | 0.15 | 3000 |
| Comparative | PET | 1.68 | ZrO₂ | 2.40 | 0.02 | 150 |
| Example 3 | | | | | | |
| Example 7 | PET | 1.68 | ZrO₂ | 2.40 | 0.02 | 1000 |
| Example 8 | PET | 1.68 | ZrO₂ | 2.40 | 0.02 | 2000 |
| Example 9 | PET | 1.68 | ZrO₂ | 2.40 | 0.02 | 3000 |
| Comparative | PET | 1.68 | ZrO₂ | 2.40 | 0.01 | 150 |
| Example 4 | | | | | | |
| Example 10 | PET | 1.68 | ZrO₂ | 2.40 | 0.01 | 1000 |
| Example 11 | PET | 1.68 | ZrO₂ | 2.40 | 0.01 | 2000 |
| Example 12 | PET | 1.68 | ZrO₂ | 2.40 | 0.01 | 3000 |
| Comparative | PET | 1.68 | ZrO₂ | 2.40 | 0.006 | 150 |
| Example 5 | | | | | | |
| Example 13 | PET | 1.68 | ZrO₂ | 2.40 | 0.006 | 1000 |
| Example 14 | PET | 1.68 | ZrO₂ | 2.40 | 0.006 | 2000 |
| Example 15 | PET | 1.68 | ZrO₂ | 2.40 | 0.006 | 3000 |
| Comparative | PET | 1.68 | ZrO₂ | 2.40 | 0.003 | 150 |
| Example 6 | | | | | | |
| Example 16 | PET | 1.68 | ZrO₂ | 2.40 | 0.003 | 1000 |
| Example 17 | PET | 1.68 | ZrO₂ | 2.40 | 0.003 | 2000 |
| Example 18 | PET | 1.68 | ZrO₂ | 2.40 | 0.003 | 3000 |
| Example 19 | PET | 1.68 | ZrO₂ | 2.40 | 0.003 | 10000 |
| Comparative | PET | 1.68 | ZrO₂ | 2.40 | 0.001 | 150 |
| Example 7 | | | | | | |
| Example 20 | PET | 1.68 | ZrO₂ | 2.40 | 0.001 | 10000 |
| Comparative | PET | 1.68 | BaTiO₃ | 2.40 | 0.01 | 100 |
| Example 8 | | | | | | |
| Example 21 | PET | 1.68 | BaTiO₃ | 2.40 | 0.01 | 3000 |
| Comparative | PET | 1.68 | TiO₂ | 2.72 | 0.01 | 100 |
| Example 9 | | | | | | |
| Example 22 | PET | 1.68 | TiO₂ | 2.72 | 0.01 | 3000 |
| Comparative | PEN | 1.77 | ZrO₂ | 2.40 | 0.01 | 100 |
| Example 10 | | | | | | |
| Example 23 | PEN | 1.77 | ZrO₂ | 2.40 | 0.01 | 3000 |
| Comparative | PC | 1.59 | ZrO₂ | 2.40 | 0.01 | 100 |
| Example 11 | | | | | | |
| Example 24 | PC | 1.59 | ZrO₂ | 2.40 | 0.01 | 3000 |
| Comparative | PMMA | 1.49 | ZrO₂ | 2.40 | 0.01 | 100 |
| Example 12 | | | | | | |
| Example 25 | PMMA | 1.49 | ZrO₂ | 2.40 | 0.01 | 3000 |
| Comparative | PS | 1.59 | ZrO₂ | 2.40 | 0.01 | 100 |
| Example 13 | | | | | | |
| Example 26 | PS | 1.59 | ZrO₂ | 2.40 | 0.01 | 3000 |
| Example 27 | PMMA | 1.49 | ZrO₂ | 2.40 | 0.003 | 10000 |
| Comparative | PET | 1.68 | ZrO₂ | 2.40 | 0.00005 | 200 |
| Example 14 | | | | | | |

Various physicalities and the results of performance evaluation of the transparent sheets or films used in the Examples and the Comparative Examples are shown in Table 2.

TABLE 2

| | transparent sheet or film | | | | | | | |
|---|---|---|---|---|---|---|---|---|
| | | Total | | frontal | | | | |
| | | light | Diffusion | luminous | | Image | Image visibility | |
| | haze | transmittance | transmittance | intensity | Viewing | clarity | Front | Rear |
| | [%] | [%] | [%] | (×1000) | angle | [%] | observation | observation |
| Comparative | 23.6 | 88 | 20.8 | 5.3 | ±30 | 86 | X | Δ |
| Example 1 | | | | | | | | |
| Example 1 | 57.5 | 82 | 47.2 | 14.0 | ±44 | 85 | ◯ | ⊚ |
| Example 2 | 76.7 | 74 | 56.8 | 14.3 | ±53 | 82 | ◯ | ⊚ |
| Example 3 | 83.8 | 70 | 58.7 | 14.6 | ±60 | 80 | ◯ | ⊚ |
| Comparative | 13.0 | 88 | 11.4 | 3.0 | ±20 | 89 | X | Δ |
| Example 2 | | | | | | | | |
| Example 4 | 37.6 | 85 | 32.0 | 9.8 | ±36 | 89 | ◯ | ⊚ |
| Example 5 | 58.6 | 82 | 48.1 | 12.9 | ±44 | 88 | ◯ | ⊚ |
| Example 6 | 70.0 | 77 | 53.9 | 16.3 | ±52 | 86 | ◯ | ⊚ |
| Comparative | 1.4 | 88 | 1.2 | 0.0 | ±10 | 89 | X | X |
| Example 3 | | | | | | | | |
| Example 7 | 7.7 | 88 | 6.8 | 3.1 | ±20 | 89 | ◯ | ⊚ |
| Example 8 | 12.9 | 87 | 11.2 | 3.7 | ±21 | 88 | ◯ | ⊚ |
| Example 9 | 16.7 | 86 | 14.4 | 4.0 | ±26 | 86 | ◯ | ⊚ |
| Comparative | 0.7 | 88 | 0.6 | 0.0 | ±7 | 89 | X | X |
| Example 4 | | | | | | | | |
| Example 10 | 4.1 | 88 | 3.6 | 2.3 | ±11 | 89 | ◯ | ⊚ |
| Example 11 | 6.8 | 87 | 5.9 | 2.4 | ±16 | 88 | ◯ | ⊚ |
| Example 12 | 8.4 | 87 | 7.3 | 2.8 | ±19 | 88 | ◯ | ⊚ |
| Comparative | 0.5 | 88 | 0.4 | 0.0 | ±6 | 90 | X | X |
| Example 5 | | | | | | | | |
| Example 13 | 2.5 | 88 | 2.2 | 1.0 | ±8 | 89 | ◯ | ⊚ |
| Example 14 | 4.4 | 88 | 3.9 | 1.1 | ±10 | 89 | ◯ | ⊚ |
| Example 15 | 4.7 | 88 | 4.1 | 1.2 | ±13 | 88 | ◯ | ⊚ |
| Comparative | 0.4 | 88 | 0.4 | 0.0 | ±5 | 90 | X | X |
| Example 6 | | | | | | | | |
| Example 16 | 2.1 | 88 | 1.8 | 0.4 | ±8 | 84 | ◯ | ⊚ |
| Example 17 | 2.9 | 88 | 2.6 | 0.4 | ±9 | 83 | ◯ | ⊚ |
| Example 18 | 2.8 | 87 | 2.4 | 0.5 | ±9 | 89 | ◯ | ⊚ |
| Example 19 | 3.2 | 86 | 2.8 | 0.6 | ±14 | 85 | ◯ | ⊚ |
| Comparative | 0.4 | 88 | 0.4 | 0.0 | ±5 | 88 | X | X |
| Example 7 | | | | | | | | |
| Example 20 | 3.2 | 86 | 2.8 | 0.5 | ±12 | 86 | ◯ | ⊚ |
| Comparative | 0.7 | 88 | 0.6 | 0.0 | ±8 | 86 | X | X |
| Example 8 | | | | | | | | |
| Example 21 | 8.0 | 87 | 7.0 | 2.9 | ±20 | 86 | ◯ | ⊚ |
| Comparative | 0.7 | 88 | 0.6 | 0.0 | ±8 | 87 | X | X |
| Example 9 | | | | | | | | |
| Example 22 | 7.2 | 87 | 6.3 | 2.9 | ±19 | 90 | ◯ | ⊚ |
| Comparative | 0.8 | 84 | 0.7 | 0.0 | ±7 | 88 | X | X |
| Example 10 | | | | | | | | |
| Example 23 | 7.9 | 84 | 6.6 | 2.7 | ±18 | 86 | ◯ | ⊚ |
| Comparative | 0.7 | 90 | 0.6 | 0.0 | ±6 | 89 | X | X |
| Example 11 | | | | | | | | |
| Example 24 | 7.7 | 89 | 6.9 | 2.6 | ±19 | 86 | ◯ | ⊚ |
| Comparative | 0.7 | 92 | 0.7 | 0.0 | ±8 | 86 | X | X |
| Example 12 | | | | | | | | |
| Example 25 | 8.2 | 92 | 7.5 | 2.6 | ±15 | 90 | ◯ | ⊚ |
| Comparative | 0.7 | 90 | 0.6 | 0.0 | ±9 | 82 | X | X |
| Example 13 | | | | | | | | |
| Example 26 | 8.1 | 90 | 7.3 | 2.5 | ±15 | 89 | ◯ | ⊚ |
| Example 27 | 3.2 | 88 | 2.8 | 0.6 | ±18 | 85 | ◯ | ⊚ |
| Comparative | 0.3 | 88 | 0.3 | 0.2 | ±3 | 92 | X | X |
| Example 14 | | | | | | | | |

### DESCRIPTION OF SYMBOLS

11 Optical diffusion layer (thick film)
12 Resin
13 Microparticle
14 Entering light
15 Diffused light
16 Viewer
17 Viewing angle (image visible region)
21 Optical diffusion layer (thin film)
22 Resin
23 Microparticle
24 Entering light
25 Diffused light
26 Diffused light viewer
27 Viewing angle (image visible region)
31 Transparent sheet (optical diffusion layer)
32 Transparent partition (support)
33 Transparent screen
34 Viewer
35A, 35B Projection device
36A, 36B Projection light
37A, 37B Diffused light

1. A transparent sheet comprising an optical diffusion layer comprising:
a resin having a refractive index n₁; and
microparticles having a refractive index n₂ different from the refractive index n₁, wherein
the thickness of the optical diffusion layer is from over 400 μm to 20 mm or less.

2. The transparent sheet according to claim 1, wherein
the optical diffusion layer satisfies the following formula (1):
Refractive index n₂−Refractive index n₁≥0.1 (1).

3. The transparent sheet according to claim 1, wherein
the content of the microparticles is from 0.0001 to 0.50% by mass based on the resin.

4. The transparent sheet according to claim 1, wherein
primary particles of the microparticles have a median diameter of from 0.1 to 100 nm and a maximum particle size of 10 to 500 nm.

5. The transparent sheet according to claim 1, wherein
the microparticles are at least one kind of inorganic microparticles selected from the group consisting of zirconium oxide, titanium oxide, zinc oxide, cerium oxide, barium titanate, diamond, and strontium titanate.

6. The transparent sheet according to claim 1, wherein
the optical diffusion layer comprises a thermoplastic resin.

7. The transparent sheet according to claim 6, wherein
the thermoplastic resin comprises at least one selected from the group consisting of an acrylic resin, a polyester resin, a polyolefin resin, a vinyl resin, a polycarbonate resin, and a polystyrene resin.

8. The transparent sheet according to claim 6 or 7, wherein
the thermoplastic resin comprises at least one selected from the group consisting of a polymethyl methacrylate resin, a polyethylene terephthalate resin, a polyethylene naphthalate resin, a polypropylene resin, a cycloolefin polymer resin, a polyvinyl butyral resin, a polycarbonate resin, and a polystyrene resin.

9. The transparent sheet according to claim 1, wherein
the total light transmittance is 70% or higher.

10. The transparent sheet according to claim 1, wherein
the diffusion transmittance is from 1.5% to 60% or less.

11. The transparent sheet according to claim 1, wherein
the haze value is 85% or less.

12. The transparent sheet according to claim 1, wherein
the image clarity is 70% or higher.

13. A transparent screen comprising the transparent sheet according to claim 1.

14. A laminated body comprising the transparent sheet according to claim 1.

15. A member for a vehicle comprising the transparent sheet according to claim 1.

16. A member for a house comprising the transparent sheet according to claim 1.

17. An image projection device comprising the transparent sheet according to claim 1, and a projection device.
